(19) United States
(12) Patent Application Publication
(10) Pub. No.: US 2019/0034909 A1
(43) Pub. Date: Jan. 31, 2019

(54) SMART BRACELET WITH ELECTRONIC CIRCUIT FOR MULTIFUNCTION ACTIVITY WITH SMARTPHONE NFC, AND ACTIVITIES FOR AUTHENTICATION COMBINED DATA (CDA) FOR PAYMENTS IN SAFETY AND CONTACTLESS

(71) Applicant: Archimedetech S.R.L., Treviso (IT)

(72) Inventor: Sisto GIRARDI, Montebelluna (TV) (IT)

(21) Appl. No.: 16/073,802

(22) PCT Filed: Dec. 12, 2016
(86) PCT No.: PCT/IT2016/000288

§ 371 Date: Jul. 29, 2018

(30) Foreign Application Priority Data
Feb. 19, 2016 (IT) 102016000017602

(51) Int. Cl. G06Q 20/32; G06Q 20/38; H04L 29/06; H04W 12/10; H04L 9/32

(52) U.S. Cl. CPC G06Q 20/3278; G06Q 20/3825; G06Q 20/385; H04L 63/0853; G06Q 50/01; H04L 9/3247; H04L 9/3228; G06Q 2220/00; H04W 12/10

(57) ABSTRACT

A smart bracelet with a display, buttons and an electronic circuit configured to perform functions with an NFC smartphone for displaying notifications and for carrying out a combined data authentication (CDA) in order to perform offline safety payments with an NFC contactless smartphone, or to perform online safety payments by means of a software applications (APP) and an NFC contactless smartphone. The smart bracelet comprises an electronic circuit with a microchip and a Bluetooth chip for performing a digital signature of a financial instrument similar to the digital signature stored in the EMV chips of smart cards, is embedded, a display and two buttons. The function of the smart bracelet is to allow the user to display the time, to display notifications of calls, sms, e-mail and social networks messages on the NFC smartphone, and to store the digital signature of a financial instrument

The present invention relates to a smart bracelet with a display, buttons and an electronic circuit configured to perform a series of autonomous and wireless connection functions with an NFC smartphone for displaying notifications and for carrying out a combined data authentication (CDA) in order to perform offline safety payments with an NFC contactless smartphone, or to perform online safety payments by means of a software applications (APP) and an NFC contactless smartphone.

The smart bracelet comprises a rubber or plastic or leather or metal support, in which an electronic circuit with a microchip and a Bluetooth chip for performing a digital signature of a financial instrument similar to the digital signature stored in the EMV chips of smart cards, is embedded, a display and two buttons. The function of the smart bracelet is to allow the user to display the time, to display notifications of calls, sms, e-mail and social networks messages on the NFC smartphone, to store the digital signature of a financial instrument and the unique secure codes identifying the NFC smartphone and its owner, to generate temporary random codes (DDA) for performing a combined data authentication (CDA) and finally also to communicate with software applications (APP) for settling contactless payments using NFC smartphones.

Different types of smart bracelets are currently known, which can be wirelessly connected with a smartphone to enable the user and/or the owner both of the bracelet and of the smartphone, to use different software applications (APP), mainly to monitor the body functions and the physical activities during a sporting practice.

Most of said objects are configured to interact, by means of internal electronic circuits, with sensors which are placed to contact the human body (for example for monitoring the heartbeat), in order to detect data which are sent to the software applications of the smartphone; other bracelets are used to perform a step count, to measure a distance traveled, to calculate burned calories, as well as other bracelets are able to show notifications of calls and messages and to manage music playlists or photo albums; some bracelets are also waterproof bracelets.

The NFC technology for contactless payments permits to make also smart bracelets configured to perform said payments by using, for example, the EMV microchip which has been recently used for credit and debit smart card. The EMV chip uses a cryptographic system to authenticate the card. At the issuance of the smart card, personal data (digital signature) which are unique for each card, are encrypted within the microprocessor. During a transaction, the POS terminal will require said data to the EMV microchip embedded in the smart card to allow the authentication (offline). Moreover, the microchip is able to generate a random code which is available only once (DDA) and which is to be “understood” and “validated” by the POS. Said smart card system with EMV microchip was introduced a decade ago as an extremely safe system, but it is however vulnerable and exposed to numerous frauds by cyber criminals.

The main problem of all electronic financial transactions, including those with smart card and EMV microchip, is the certification of the “authenticity” of the system and/or of the objects (for example, in the case of the smart card the problem is that said card was not cloned). Therefore, a smart bracelet that uses the only EMV microchip has the same risks identified above for the smart cards.

Analogously, online payment systems using NFC smartphones with a virtualized credit or debit card show the same safety problems, as there is a risk of loss, theft or fraudulent tampering of the NFC smartphone by cyber criminals.

To ensure a higher level of security it was decided to use a “combined data authentication” (CDA), by using other enabling codes (passwords or temporary random codes) which are online verified, for example through the Host Card Emulation (HCE) technology, and which can be used with an NFC smartphone and a suitable software application (APP). However, security risks cannot be completely avoided because even the online communication can be intercepted and data can be stolen by cyber criminals.

The object of the present invention is therefore to obviate the above mentioned technical drawbacks and, in particular, to provide a smart bracelet that allows, by using an NFC smartphone, a multiple and combined authentication, both offline and online, of the personal and financial data for obtaining safety payments by using contactless smartphones with NFC technology.

Advantageously, the present invention relates to a smart bracelet including an electronic circuit with an embedded Bluetooth chip and a microchip, which performs a digital signature of a financial instrument and which permits a unique authentication of the NFC smartphone and of its rightful owner and which also permits a combined data authentication (CDA) for safe payment activities, by using an NFC contactless smartphone. The special feature of said smart bracelet is to allow a multiple and combined offline authentication, without any passage of sensitive data on the web.

Therefore, the smart bracelet and the NFC smartphone, by performing an offline authentication, allow the following activities in order to obtain safety payments:

1. data (encrypted) storage relating to the digital signature of a credit or debit card and/or a bank account, provided by a bank or financial institution, said data being stored in the microchip coupled to the electronic circuit of the smart bracelet;

2. data (encrypted) storage relating to a joint authentication of the NFC smartphones and of its owner, by using suitable secure codes stored in the electronic circuit;

3. creating a temporary random code (DDA) by means of the electronic circuit of the smart bracelet;

4. confirming the authentication of the temporary random code (DDA) with respect to the code stored on the microchip and related to the digital signature of the financial instrument which is stored in the electronic circuit of the smart bracelet;

5. sending to the NFC smartphone the secure codes stored on the electronic circuit of the smart bracelet and verifying the matching of said secure codes with the secure codes of the smartphone;

6. payment performing with the NFC smartphone in contactless mode when said matching is verified.

Alternatively, the smart bracelet, together with the NFC smartphone, by performing an online authentication, allows safety payments with the following activities:

1. data (encrypted) storage relating to the joint authentication of the NFC smartphone and its owner, by using suitable secure codes stored on the electronic circuit;

2. creating a temporary random code (DDA) by means of the electronic circuit of the smart bracelet;

3. sending to the NFC smartphone the secure codes stored on the electronic circuit of the smart bracelet and the temporary random code (DDA) created by the electronic circuit of the smart bracelet;

4. verifying the matching between the secure codes stored on the electronic circuit of the smart bracelet and the actual data relating to the pairing smartphone/owner and, if said matching is verified, sending online, through the NFC smartphone, said temporary random code (DDA) to the bank or financial institution server for verifying said random code;

5. payment performing with the NFC smartphone in contactless mode when said matching is verified.

Further technical features and advantages of the smart bracelet, according to the present invention, will be more clear from the following description of two preferred embodiments and from the enclosed drawings, in which:

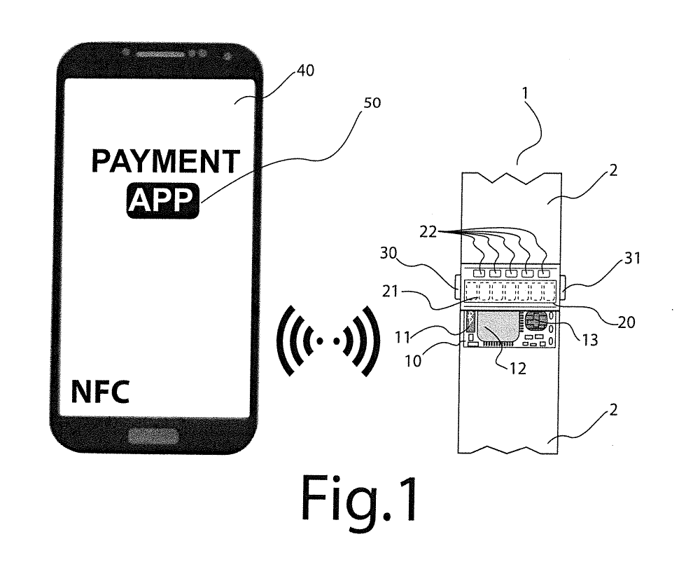

FIG. 1a shows the components of the smart bracelet, according to the invention;

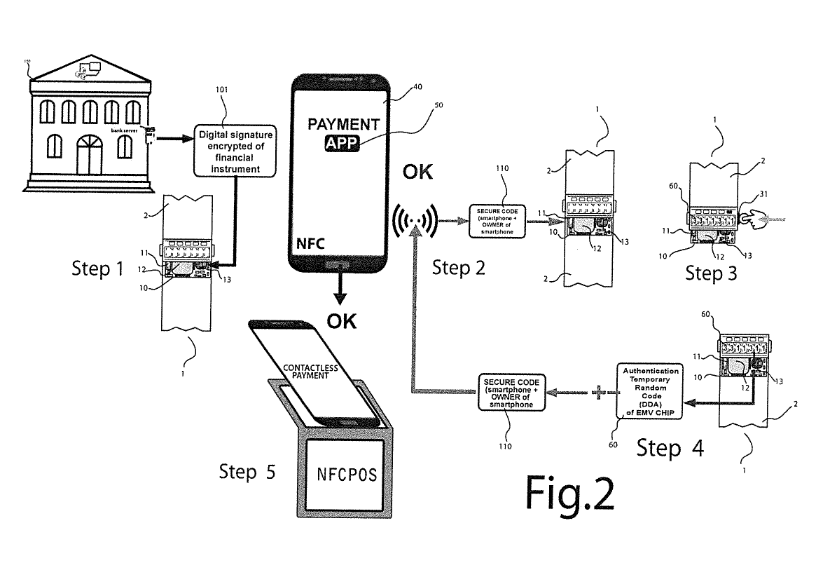

FIG. 2 shows the different phases for performing a verified offline authentication of the combined data (CDA), including a joint authentication of the NFC smartphone and of its owner and of the temporary random code (DDA) for safety payments, according to the invention;

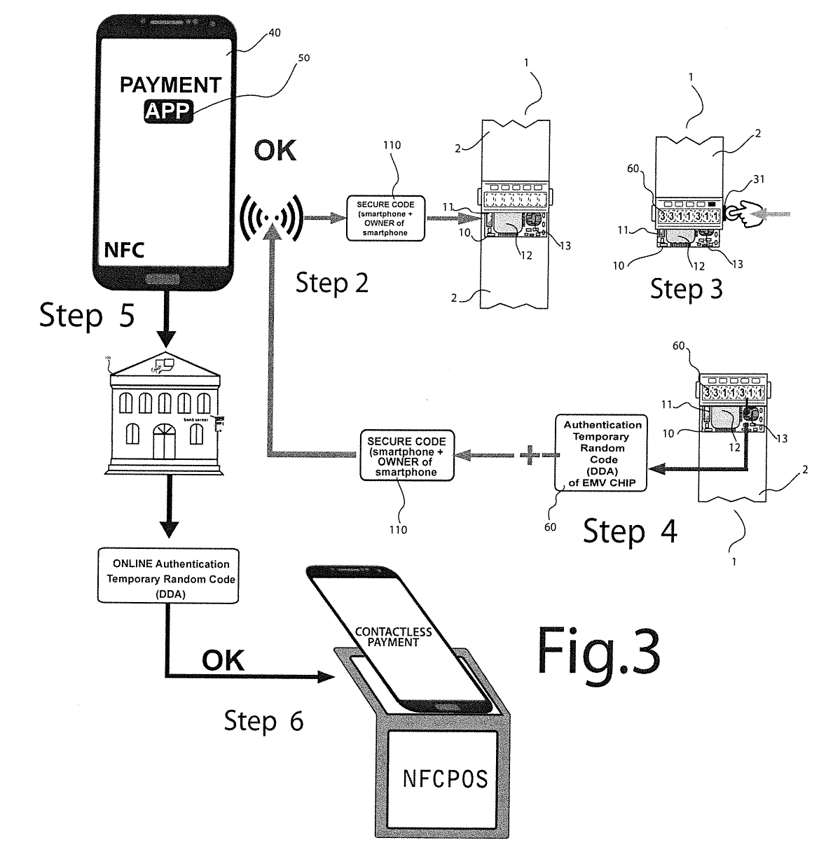

FIG. 3 shows the different phases for performing an online authentication of combined data (CDA), including a joint authentication of the NFC smartphone and of its owner and of the temporary random code (DDA) through access to the bank or financial institute server, for performing safety payments, according to the invention;

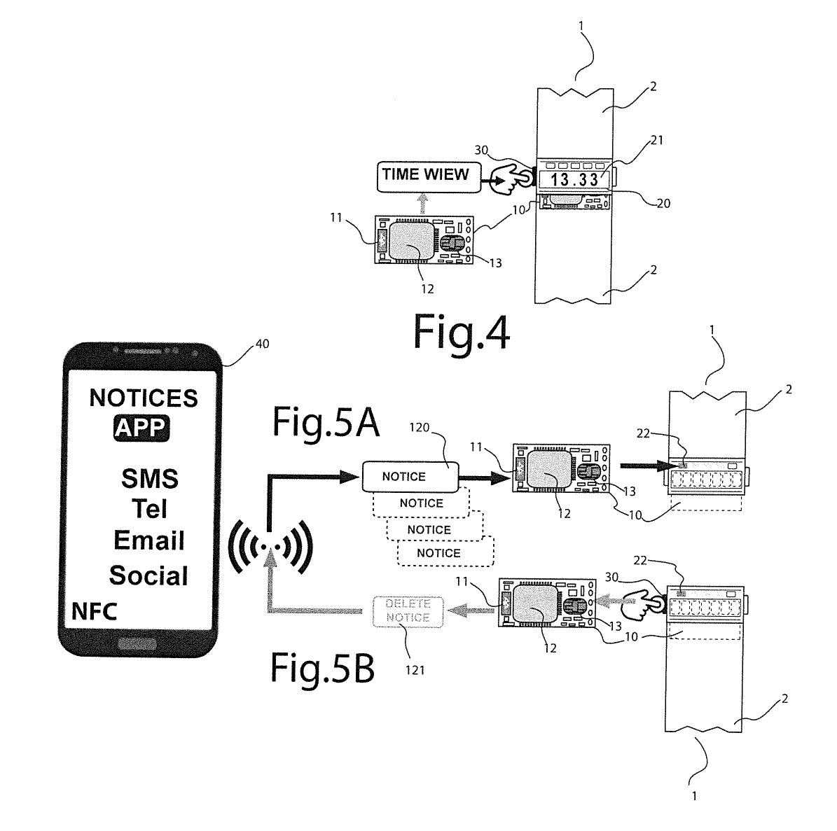

FIG. 4 shows a first function of the smart bracelet, according to the invention;

FIGS. 5A and 5B show the management of notifications on the smart bracelet which is wirelessly connected to the NFC smartphone, according to the invention.

With reference to the above mentioned figures, the smart bracelet (1) comprising a strap (2) made of plastic or rubber or leather or metal and an electronic circuit (10) on which are embedded a Bluetooth chip (11), a CPU (12), a microchip (13), a display (20) and two buttons (30, 31), permits, together with an NFC smartphone (40), to make safety offline and contactless payments by acting according to the following phases:
a bank or financial institution (100) is able to store on the smart bracelet (1) and in particular on the microchip (13) embedded in the electronic circuit (10), encrypted data relating to the signing of a financial instrument (101);
a software application of the NFC smartphone (40) allows to wirelessly store on the smart bracelet (1) and, in particular, on the electronic circuit (10),
   encrypted data relating both to the authentication of the smartphone and to the authentication of the owner of said smartphone, through the secure code (110);
the owner of the smart bracelet (1), by pushing the button (31) to the right of the display (20) and by means of the software application which manages the smart bracelet (1), is able to create a temporary random code (DDA) (60), which is compared with the digital signature stored on the microchip (13);
when a matching between the temporary random code (DDA (60) and the digital signature is verified, the software application which manages the smart bracelet (1) send wirelessly to the NFC smartphone (40) the encrypted secure codes (110) of the electronic circuit (10), which are configured to identify the smartphone (40) and the owner of said smartphone;
the software application of the NFC smartphone (40) compares the secure codes (110) with the actual data for pairing the smartphone and the owner and, if a matching is verified, allows the NFC smartphone (40) to perform the payment in a contactless mode.

Alternatively, the smart bracelet (1), together with the NFC smartphone (40), is configured to make online safety and contactless payments according to the following phases:
a software application of the NFC smartphone (40) wirelessly stores on the smart bracelet (1) and, in particular, on the electronic circuit (10), encrypted data relating both to the authentication of the smartphone and to the authentication of the owner of said smartphone, through a secure code (110);
the owner of the smart bracelet (1), by pushing the button (31) to the right of the display (20) and by means of a software application which manages the smart bracelet (1), is able to create a temporary random code (DDA) (60) which is wirelessly sent to the NFC smartphone (40), together with the encrypted secure codes (110) of the electronic circuit (10), which identify the smartphone (40) and the owner of the smartphone;
the software application of the NFC smartphone (40) compares the secure codes (110) with the actual data for pairing the smartphone and the owner and, when the matching is verified, allows the NFC smartphone (40) to contact the bank or financial institution server (100) for performing the authentication of the temporary random code (DDA) (60);
when the matching is verified, the software application of the NFC smartphone (40) allows the NFC smartphone (40) to perform the payment in a contactless mode.

The smart bracelet (1) also has other functions when not coupled to the NFC smartphone (40) and is able to display notifications of calls, sms, e-mails and other messages received by the NFC smartphone (40). For example, to display the time the owner can use the button to the left (30) of the display (20) so that the software application which manages the smart bracelet (1) shows the time in the middle of the display (21); the display will remain active for 30 seconds. Regarding the notification management (120), the software application which manages the smart bracelet (1), when said bracelet (1) is wirelessly connected with the NFC smartphone (40), shows on the top of the display (20) a few drawings (22) having different colors depending on whether a phone call, a text message, an e-mail or a message from social networks is coming. It is also possible to remove (121) the notification from the display by pressing the left button (30) of the bracelet (1).

The invention thus conceived and illustrated herein is susceptible to numerous modifications and variations, all falling within the inventive concept of the appended claims.

Moreover, all the details may be replaced with other technically equivalent elements.

Finally, the components used, so long as compatible with the specific use, as well as the dimensions, may be any according to requirements and the state of the art.

Where the features and techniques mentioned in the appended claims are followed by reference signs, said reference signs have been included for the sole purpose of increasing the understanding of the appended claims and accordingly said reference signs do not have any limiting effects on the interpretation of each element identified by way of example by said reference signs.

1. Smart bracelet (1) including an electronic circuit (10) with an integrated Bluetooth chip (11), a CPU (12) and a microchip (13) for a digital signature (101) of a financial instrument, configured to make a unique authentication of a NFC smartphone (40) and of its rightful owner and a multiple and combined data authentication (CDA) for secure payment activities using said NFC smartphone (40) in a contactless mode, wherein on said microchip (13) are stored encrypted data relating to said digital signature (101) of the financial instrument provided by a bank or financial institution, as well as the encrypted data of combined authentication of said NFC smartphone (40) and of the owner through safety codes (110), which are configured to identify said NFC smart phone (40), characterized in that said CPU (12) is configured to generate a temporary random code (DDA) (60) to be compared with said encrypted data related to said digital signature and in that said safety codes (110) are sent wirelessly to said NFC smartphone (40) when a matching between said temporary random code (DDA) (60) and the digital signature is verified.

2. Smart bracelet (1) according to claim 1, characterized in that said safety codes (110) and said temporary random code (DDA) are jointly sent to said NFC smartphone (40) for a first check of the actual data related to the pairing between said NFC smartphone (40) and the owner, said temporary random code (DDA) being sent online, through said NFC smartphone (40), to a server of said bank or financial institution for a second check, in case of a positive outcome of said first check.

3. Smart bracelet (1) according to claim 1, characterized in that said bracelet (1) includes a strap (2) made of plastic or rubber or leather or metal, a display (20) and operating push-buttons (30, 31).

4. Smart bracelet (1) according to claim 3, characterized in that said operating push-buttons (30, 31) are pressed to generate said temporary random code (DDA) (60) which is wirelessly sent to said NFC smartphone (40).

5. Smart bracelet (1) according to claim 3, characterized in that said display (20) displays notifications of calls, sms, e-mails and messages from social networks.

6. Smart bracelet (1) according to claim 5, characterized in that said display (20) displays the time and is configured to manage said notifications by means of graphical icons and by means of said operating push-buttons (30, 31).
